(19) United States
(12) Patent Application Publication
(10) Pub. No.: US 2019/0279545 A1
(43) Pub. Date: Sep. 12, 2019

(54) SYSTEM OF INSPECTING DISPLAY PANEL AND METHOD OF INSPECTING DISPLAY PANEL

(71) Applicant: SHARP KABUSHIKI KAISHA, Sakai City (JP)

(72) Inventors: HIDEKI SHINOBU, Sakai City (JP); NOBUYUKI KAWASE, Sakai City (JP); TERUO KAWAMURA, Sakai City (JP)

(21) Appl. No.: 16/294,571

(22) Filed: Mar. 6, 2019

(30) Foreign Application Priority Data
Mar. 9, 2018 (JP) 2018-042741

(51) Int. Cl. G09G 3/00; G02F 1/13

(52) U.S. Cl. CPC G09G 3/006; G02F 2001/1316; G02F 1/1309

(57) ABSTRACT

A system of inspecting a display panel includes an inspection apparatus configured to determine whether the display panel has a lighting defect. If determining that the display panel has a lighting defect, the inspection apparatus is configured to make a cleaner to clean a portion of the display panel having the lighting defect. The inspection apparatus is configured to determine presence or absence of the lighting defect again at least on the portion of the display panel having the lighting defect after the cleaning. The inspection apparatus determines that the display panel has no defect if detecting no lighting defect after the cleaning or if determining that pre-cleaning lighting defect information and post-cleaning lighting defect information does not match, and the inspection apparatus determines that the display panel has a defect if determining that the pre-cleaning lighting defect information and the post-cleaning lighting defect information match.

### CROSS REFERENCE TO RELATED APPLICATION

This application claims priority from Japanese Patent Application No. 2018-042741 filed on Mar. 9, 2018. The entire contents of the priority application are incorporated herein by reference.

### TECHNICAL FIELD

The technology described herein relates to a system of inspecting a display panel that, in a process of producing a display device, conducts an inspection of a display panel included in the display device, and relates also to a display panel inspection method of inspecting a display panel.

### BACKGROUND

In a process of producing various display devices, such as a liquid crystal display, a plasma display, and an organic EL display, an inspection to see whether a display panel included in a display device is normal, more specifically, an inspection to see whether the display panel is lighted on normally is conducted. A lighting defect of the display panel is caused by a defect in the display panel. For example, lighting defects may be caused by a damage to the display panel, disconnection of scanning lines or signal lines, a line defect resulting from short circuit, mixture of impurity into the display panel during a molding process, or the like. Methods of detecting a lighting defect of a display panel are known. Those methods include a method of detecting a lighting defect based on an image captured by an image-capturing device (microscope) and a method of detecting a lighting defect based on image data created by processing incoming reflection light from the surface of the display panel on which light is emitted. However, these methods, by which a lighting defect of the display panel is detected through image processing, may lead to a case where foreign matter, such as dust and dirt, deposited on the surface of the display panel is determined also to be a lighting defect. Examples of these methods are disclosed in Japanese Unexamined Patent Application Publication No. 2009-155158 and Japanese Unexamined Patent Application Publication No. H10-19734.

Techniques of dealing with such a lighting defect caused by foreign matter have been proposed. For example, in Japanese Unexamined Patent Application Publication No. 2009-155158, an operator determines whether it is a foreign matter based on a magnified image captured by a microscope and when determining that foreign matter is deposited on the display panel, the foreign matter is removed. Japanese Unexamined Patent Application Publication No. H10-19734 describes a technique of checking a display panel to see whether a foreign matter is deposited thereon before conducting an inspection of the display panel and, upon finding the foreign matter on the display panel, removing the foreign matter.

According to the technique described in Japanese Unexamined Patent Application Publication No. 2009-155158, the operator has to find out whether any foreign matter is deposited on the display panel and could make an error in determining the presence/absence of a foreign matter. Since the operator has to check several spots to see whether foreign matter is present there, inspection time becomes longer. According to the technique described in Japanese Unexamined Patent Application Publication No. H10-19734, before an inspection of the display panel is conducted, determination of whether foreign matter is deposited on the display panel must be made first. This also leads to a problem of a longer inspection time.

### SUMMARY

The technology described herein was made in view of the above circumstances. An object is to provide a system of inspecting a display panel and a method of inspecting a display panel, the system and the method allowing an inspection of a display panel to be conducted accurately and efficiently.

A system of inspecting a display panel according to the technology described herein conducts an inspection of a display panel included in a display device in a process of producing the display device. The system includes an inspection apparatus and a cleaner configured to clean a surface of the display panel. The inspection apparatus is configured to obtain an image of the display panel relating a lighting condition thereof and process the image and determine whether the display panel has a lighting defect. If determining that the display panel has a lighting defect, the inspection apparatus is configured to obtain lighting defect information relating the lighting defect, store the lighting defect information, and make the cleaner to clean at least a portion of the display panel having the lighting defect. The inspection apparatus is configured to determine presence or absence of the lighting defect again at least on the portion of the display panel having the lighting defect after the cleaning. The inspection apparatus determines that the display panel has no defect if detecting no lighting defect after the cleaning or if determining that pre-cleaning lighting defect information and post-cleaning lighting defect information does not match, and the inspection apparatus determines that the display panel has a defect if determining that the pre-cleaning lighting defect information and the post-cleaning lighting defect information match.

According to the system of inspecting a display panel (which will hereinafter be simply referred to as “inspection system”) configured in the above manner, only when a lighting defect on the display panel is detected at the first inspection, cleaning and a re-inspection are carried out. This allows conducting an efficient inspection of the display panel. The above “lighting defect information” is a statement including description of the position, shape, size, and the like of a lighting defect. If a lighting defect is caused by dust or dirt, cleaning the dust or dirt ought to cause the lighting defect to disappear or reduce in size or displace. Taking that assumption into consideration, the inspection system of the above configuration determines whether a lighting defect is caused by a defect of the display panel, based on whether pre-cleaning lighting defect information and post-cleaning lighting defect information match. This allows an inspection of the display panel to be conducted accurately, compared to a case where an operator determines whether a lighting defect is caused by a defect of the display panel by making a visual check. The inspection system automatically determines whether the pre-cleaning lighting defect information and the post-cleaning lighting defect information match. This allows an inspection of the display panel to be conducted more efficiently, compared to a case where an operator determines whether a lighting defect is caused by a defect of the display panel by making a visual check.

An inspection of the display panel, the inspection being configured in the above manner, may be conducted at any stage of a process of producing a display device and may be conducted several times. For example, the inspection may be conducted as an inspection of the display panel in various states, such as a state in which the display panel has been assembled into the display device, a state in which a backlight is not attached to the display panel (liquid crystal panel) yet, and a state in which the backlight and polarizers are not attached to the display panel (liquid crystal panel) yet.

The inspection system may be configured such that the display-device-in-process to be inspected is moved between the inspection apparatus and the cleaner or such that the display-device-in-process to be inspected is not moved and at least one of the inspection apparatus and the cleaner is moved instead. The latter configuration is a configuration in which, for example, a conventional inspection apparatus is provided with the cleaner and a shifter that shifts the cleaner.

A method of inspecting a display panel according to the technology described herein includes a lighting defect detecting process of obtaining an image of the display panel relating a lighting condition thereof and processing the image and determining presence or absence of the lighting defect, and obtaining lighting defect information relating the lighting defect, a cleaning process of cleaning at least a portion of the display panel having the lighting defect according to determination that the display panel has a lighting defect, and a defect detecting process of determining presence or absence of the lighting defect again at least on the portion of the display panel having the lighting defect. In the defect detecting process, it is determined that the display panel has no defect if detecting no lighting defect after the cleaning or if determining that pre-cleaning lighting defect information and post-cleaning lighting defect information does not match, and it is determined that the display panel has a defect if determining that the pre-cleaning lighting defect information and the post-cleaning lighting defect information match.

According to this method of inspecting a display panel, in the same manner as in the above-described system of inspecting a display panel, only when a lighting defect in the display panel is detected at the first inspection, cleaning and a re-inspection are carried out. This allows conducting an efficient inspection of the display panel. Whether a lighting defect is caused by a flaw of the display panel is determined based on whether pre-cleaning lighting defect information and post-cleaning lighting defect information match. This allows an inspection of the display panel to be conducted accurately, compared to a case where a worker determines whether a lighting defect is caused by a flaw of the display panel by making a visual check. Whether the pre-cleaning lighting defect information and the post-cleaning lighting defect information match is automatically determined. This allows an inspection of the display panel to be conducted more efficiently, compared to a case where a worker determines whether a lighting defect is caused by a flaw of the display panel by making a visual check.

The system and method for inspecting a display device according to the technology described herein can inspect a display panel accurately and efficiently.

### BRIEF DESCRIPTION OF THE DRAWINGS

FIG. 1 is a schematic view of a system of inspecting a display panel according to a first embodiment.

FIG. 2 is a plan view of a liquid crystal module to be inspected by the system of inspecting a display panel according to the first embodiment.

FIG. 3 is a sectional view of the liquid crystal module to be inspected by the system of inspecting a display panel according to the first embodiment.

FIG. 4 depicts a flowchart of a liquid crystal panel inspection program executed by the system of inspecting a display panel according to the first embodiment.

FIG. 5 is a schematic view of a system of inspecting a display panel that is a modification of the system of inspecting a display panel according to the first embodiment.

FIG. 6 is a schematic view of a system of inspecting a display panel that is another modification of the system of inspecting a display panel according to the first embodiment.

FIG. 7 is a schematic view of a system of inspecting a display panel that is still another modification of the system of inspecting a display panel according to the first embodiment.

FIG. 8A is a plan view schematically showing a system of inspecting a display panel according to a second embodiment.

FIG. 8B is a plan view schematically showing a system of inspecting a display panel according to another example of the second embodiment.

### DETAILED DESCRIPTION

Some embodiments of the technology described herein will hereinafter be described in detail with reference to drawings, as modes for carrying out the technology. The technology described herein will not be limited to the embodiments described below, and may be modified or improved in various manners, based on knowledge of those who skilled in art, to be carried out in various modes.

### First Embodiment

<Configuration of System of Inspecting Display Panel>

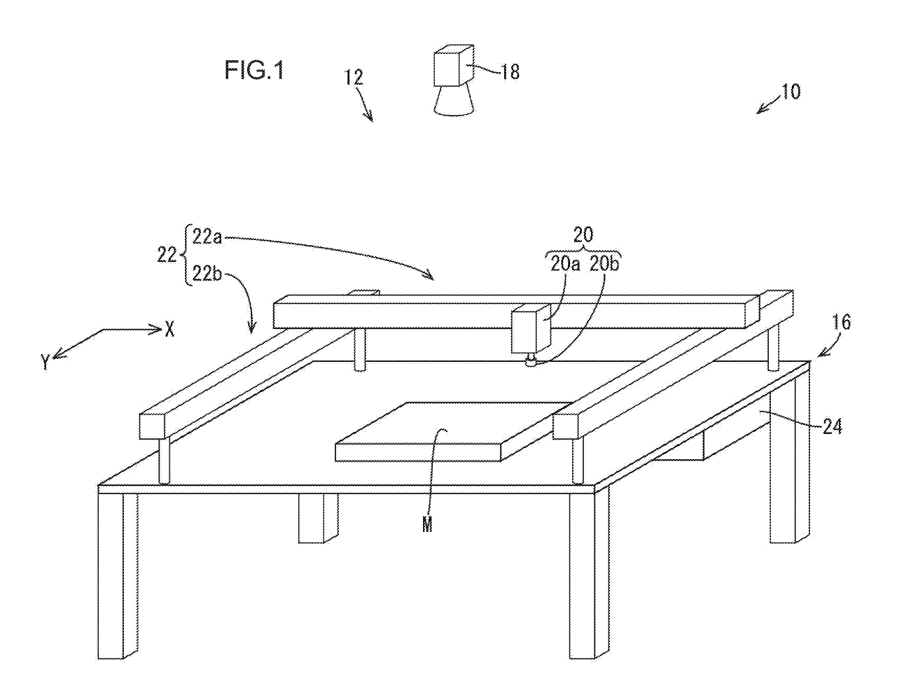

A system 10 for inspecting a display panel (which will hereinafter be referred to simply as “inspection system 10” in some cases) according to a first embodiment is shown in FIG. 1. The inspection system 10 includes an inspection apparatus 12 that serves as a main unit and that inspects a liquid crystal panel included in a liquid crystal module M working as a display device. The inspection apparatus 12 has a cleaning function as an additional function. The inspection system 10 includes a mounting table 16 on which the completed liquid crystal module M to be inspected or the liquid crystal module M in a state of a work-in-process is placed (FIG. 1 shows the completed liquid crystal module M placed on the mounting table 16), a camera 18 disposed above the mounting table 16, a cleaner 20 that cleans the liquid crystal module M placed on the mounting table 16, a cleaner shifter 22 that shifts the cleaner 20 to any given location on the mounting table 16, and a controller 24 that controls operations of the inspection system 10. In the inspection system 10, a part of inspection system 10 that does not include the cleaner 20 and the cleaner shifter 22 is regarded as the inspection apparatus 12.

The camera 18 is configured to take an overall image of an object to be inspected placed on the mounting table 16 or take a magnified image of a part of the object. The cleaner 20 includes a cleaning head 20a and a cleaning jig 20b attached to the cleaning head 20a. In FIG. 1, the cleaning jig 20b is stick-shaped and is configured to clean a portion of a liquid crystal panel 30, wiping dirt, such as fats and oils, away or sucking up dust. Hereinafter, the cleaning jig 20b will be referred to as cleaning stick 20b. The cleaner shifter 22 includes an X direction shifter 22a that shifts the cleaning head 20a in the X direction, and a Y direction shifter 22b that shifts the X direction shifter 22a in the Y direction. The cleaner shifter 22 thus shifts the cleaning head 20a to any given location on the mounting table 16. The cleaning head 20a has a jig lift (not depicted) that moves the cleaning stick 20b up and down, and is configured to bring the cleaning stick 20b into contact with the surface of the liquid crystal panel 30. The controller 24 is connected to the camera 18, the cleaner 20, and the cleaner shifter 22, and is configured to control operations of these camera 18, cleaner 20, and cleaner shifter 22.

<Configuration of Object to be Inspected (Liquid Crystal Module)>

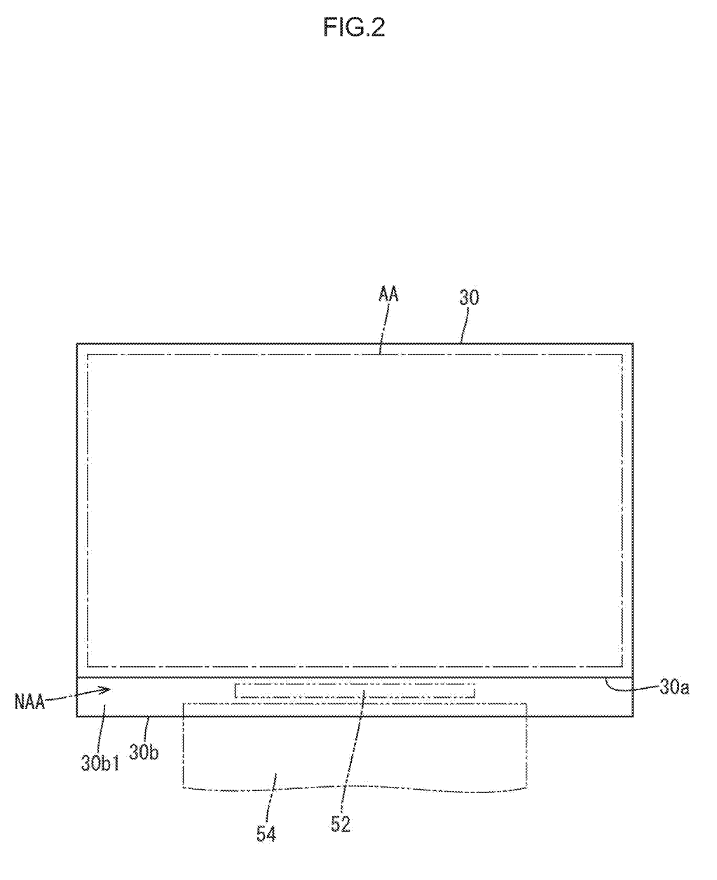

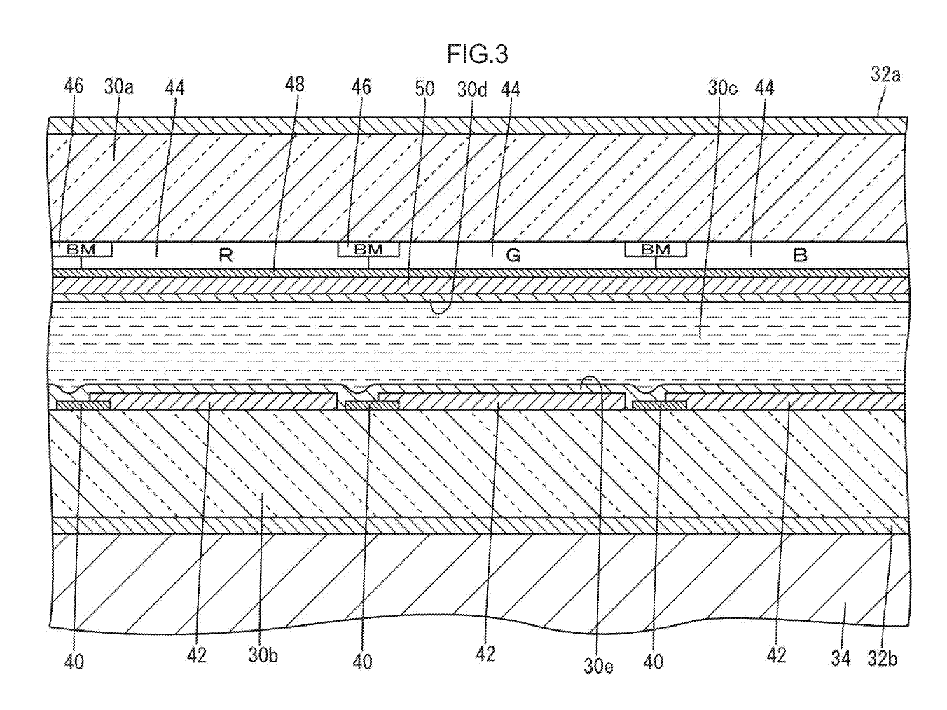

The liquid crystal module M to be inspected by the inspection system 10 will then be described. As shown in FIG. 2, the liquid crystal module M is of a laterally elongated rectangle as a whole. As shown in FIG. 3, the liquid crystal module M includes the liquid crystal panel 30 working as a display panel configured to display an image, a pair of polarizers 32a and 32b pasted respectively on both sides of the liquid crystal panel 30, and a backlight 34 disposed on the back side of the polarizer 32b pasted on the back side of the liquid crystal panel 30, the backlight 34 emitting light onto the liquid crystal panel 30. As shown in FIG. 2, a display surface of the liquid crystal panel 30 is divided into a display area (active area) AA having an image displayed therein and a non-display area (non-active area) NAA of a frame shape encircling the display area AA, the non-display area NAA having no image displayed therein. In FIG. 2, a one-dot chain line represents the outline of the display area AA, and an area outside the one-dot chain line is the non-display area NAA.

The liquid crystal panel 30 has a pair of transparent (highly translucent) substrates 30a and 30b, and a liquid crystal layer 30c interposed between the substrates 30a and 30b, the liquid crystal layer 30c containing liquid crystal molecules that change in optical properties when exposed to an electric field applied thereto. The substrates 30a and 30b kept separated apart across a cell gap as thick as the liquid crystal layer 30c are pasted together with a sealant (not depicted). The substrates 30a and 30b are each fabricated by stacking films on a substantially transparent glass substrate by a known method, such as photolithography. Of the substrates 30a and 30b, the substrate on the front side (front surface side) serves as a CF substrate (counter substrate) 30a, and the substrate on the back side (back surface side) serves as an array substrate (thin-film transistor substrate or active matrix substrate) 30b. On the inner surface side of the substrate 30a and on the same of the substrate 30b, an oriented film 30d and an oriented film 30e for orienting liquid crystal molecules included in the liquid crystal layer 30c are formed, respectively.

Of the pair of substrates 30a and 30b, the array substrate 30b disposed on the back side carries numbers of switching elements (e.g., thin-film transistors or TFTs) 40 connected to source lines and gate lines perpendicular to each other, and number of pixel electrodes 42 connected to the switching elements 40, the switching elements 40 and the pixel electrodes 42 being arranged in a matrix formation. These switching elements 40 and pixel electrodes 42 are overlaid with the above-described oriented film 30e. The CF substrate (counter substrate) 30a disposed on the front side carries a color filter 44 composed of colored portions R (red), G (green), and B (blue) arranged in given patterns, and black matrixes (shading films) 46 partitioning colored portions adjacent to each other. These color filter 44 and black matrixes 46 are overlaid with an overcoat film 48, which is overlaid with a counter electrode 50 made of a transparent electrode material, such as indium tin oxide (ITO). The counter electrode 50 is then overlaid with the above-described oriented film 30d.

As shown in FIG. 2, the array substrate 30b has short sides longer than that of the CF substrate 30a, and is pasted to the CF substrate 30a such that the array substrate 30b sticks out in the direction of the short sides, relative to the CF substrate 30a. A part of array substrate 30b that does not overlap the CF substrate 30a is a CF substrate non-overlapping portion 30b1. The CF substrate non-overlapping portion 30b1 has a driver 52 for liquid crystal panel (panel driver) mounted by chip-on-glass (COG) mounting, the driver 52 driving the switching elements 40 or the like in the display area AA. The CF substrate non-overlapping portion 30b1 is connected to a flexible board 54 for liquid crystal panel (connection member for display panel) that has a function of transmitting a signal related to a display function to the driver 52 for liquid crystal panel.

<Method of Inspecting Display Panel>

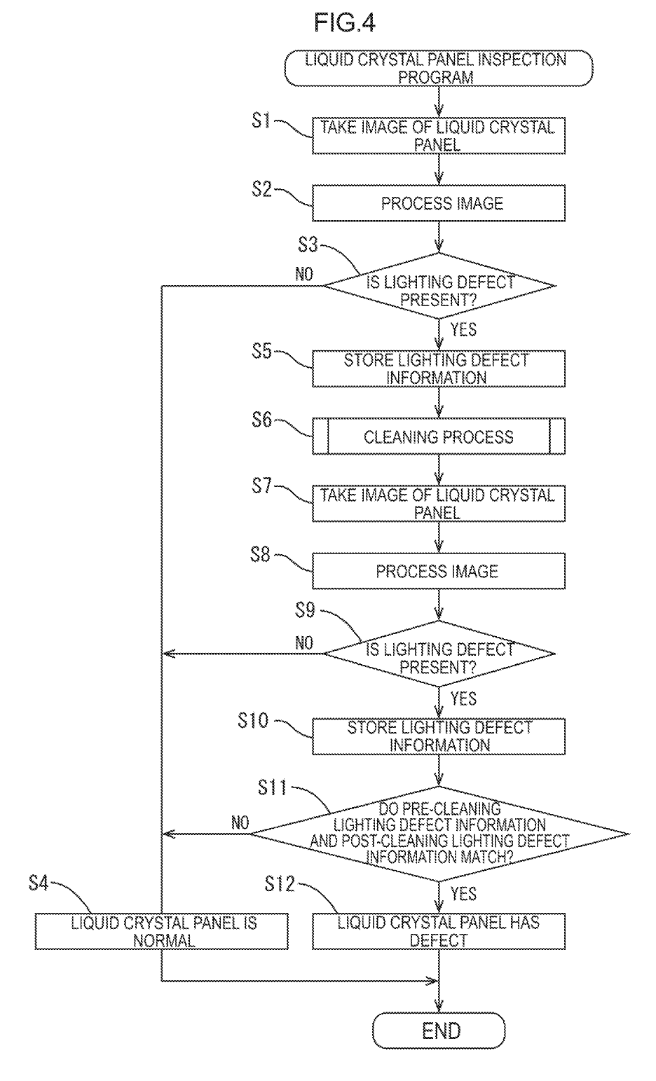

The inspection system 10 is used in a process of producing the liquid crystal module M configured in the above manner. An inspecting method carried out by the inspection system 10 will hereinafter be described in detail with reference to a flowchart of a liquid crystal inspection program shown in FIG. 4.

(I) Lighting Defect Detecting Process

FIG. 1 depicts a case where the liquid crystal panel 30 of the produced liquid crystal module M is inspected, showing the produced liquid crystal module M being placed on the mounting table 16. The inspection system 10 first determines whether the liquid crystal module M has a lighting defect. Specifically, at step 1 (which will be abbreviated as S1 in some cases and other steps will also be abbreviated in the same manner), the controller 24 causes the camera 18 to take an overall image of the liquid crystal panel 30 of the liquid crystal module M. At S2, the controller 24 obtains image data of the image taken by the camera 18, processes the image data, and, at S3, determines whether the liquid crystal panel 30 has a lighting defect. For example, the controller 24 causes the liquid crystal module M to display black across the surface of the liquid crystal panel 30, and when finding a lighting spot on the black surface, determines that the liquid crystal panel 30 has a lighting defect. When determining that the liquid crystal panel 30 has a lighting defect, the controller 24, at S5, stores lighting defect information including information of the location, shape, size, and the like of the lighting defect. If the lighting defect is a tiny one, the controller 24 causes the camera 18 to take a magnified image of a spot of the lighting defect, and obtains image data of the magnified image. If the liquid crystal panel 30 has no lighting defect, the liquid crystal module M is determined to be normal at S4, and the inspection is ended.

(II) Cleaning Process

When determining that the liquid crystal panel 30 has a lighting defect, the controller 24, at S6, causes the cleaner shifter 22 to shift the cleaner 20 to a spot where the lighting defect is detected. Subsequently, the jig lift of the cleaning head 20a moves down the cleaning stick 20b to bring it into contact with the liquid crystal panel 30. The cleaner shifter 22 then causes the cleaning stick 20b to operate to clean the liquid crystal panel 30. If several spots of lighting defects are present, the cleaning stick 20b is moved up after finishing with cleaning one spot and then the cleaner 20 is shifted to the next spot of a lighting defect to carry out cleaning in the same manner. If all the spots of lighting defects are cleaned, the cleaner 20 is shifted back to a stand-by position outside the liquid crystal module M.

(III) Defect Detecting Process

After completion of cleaning of the liquid crystal panel 30, whether the liquid crystal panel 30 has a lighting defect is determined again at S7 to S9. If the liquid crystal panel 30 has several spots of lighting defects, the camera 18 takes an overall image of the liquid crystal panel 30, and the controller 24 determines whether the liquid crystal panel 30 has a lighting defect based on image data of the overall image. If it is determined that the above lighting defect disappears, the liquid crystal module M is determined to be normal at S4, and the inspection is ended.

If a lighting defect is still present, the controller 24, at S10, obtains post-cleaning lighting defect information. At S11 following S10, the controller 24 compares pre-cleaning lighting defect information with post-cleaning lighting defect information to determine whether a lighting defect of which pre-cleaning lighting defect information and post-cleaning lighting defect information match completely in the location, shape, and size of the lighting defect is present. If a lighting defect is caused by dust or dirt, cleaning the dust or dirt ought to cause the lighting defect to change in shape or reduce in size or displace. When a lighting defect of which pre-cleaning lighting defect information and post-cleaning lighting defect information match completely is not present, therefore, it is determined at S4 that the liquid crystal module M is normal. When a lighting defect of which pre-cleaning lighting defect information and post-cleaning lighting defect information match completely is present, on the other hand, it is determined at S12 that the liquid crystal panel 30 of the liquid crystal module M has a defect. An inspection of one liquid crystal module M is then ended.

As described above, according to the inspection system 10, whether a lighting defect is caused by a defect of the liquid crystal panel 30 is determined, based on whether pre-cleaning lighting defect information and post-cleaning lighting defect information match. This allows an inspection of the liquid crystal panel 30 to be conducted more accurately, compared to a case where an operator determines whether a lighting defect is caused by foreign matter or a defect by making visual check. The controller 24 automatically determines whether the pre-cleaning lighting defect information and the post-cleaning lighting defect information match. This allows an inspection of the liquid crystal panel 30 to be conducted more efficiently, compared to a case where an operator determines whether a lighting defect is caused by a defect of the liquid crystal panel 30 by making visual check.

The cleaning process by the inspection system 10 may be carried out as a simple process for detecting a defect of the liquid crystal panel 30. Such a simple cleaning process will reduce a time required for cleaning and therefore reduce an inspection time. According to the inspection system 10, because the cleaner 20 is configured to clean a part of the liquid crystal panel 30, a time required for cleaning can be reduced, compared to a case where the liquid crystal panel 30 is cleaned as a whole.

In the lighting defect detecting process, when a magnified image of a spot of a lighting defect is taken to obtain lighting defect information, a magnified image of the spot is taken again after cleaning to obtain another piece of lighting defect information. Pre-cleaning lighting defect information and post-cleaning lighting defect information obtained from these magnified images are then compared with each other. Specifically, in the lighting defect detecting process, when a spot of the lighting defect of which a magnified image has been taken is the only one spot of a lighting defect that has been detected, a determination on the presence/absence of a lighting defect is made only on that spot in the defect detecting process. In such a case, whether a lighting defect is caused by a defect of the liquid crystal panel 30 is determined based on lighting defect information obtained by processing a magnified image of a lighting defect. This allows conducting a more accurate inspection of the liquid crystal panel 30.

<Modifications>

The inspection system 10 according to the first embodiment is used to conduct an inspection of the liquid crystal panel 30 of the liquid crystal module M that has been produced. However, the inspection system 10 may also be used to conduct an inspection of the liquid crystal panel 30 of the liquid crystal module M that is still in a stage of production.

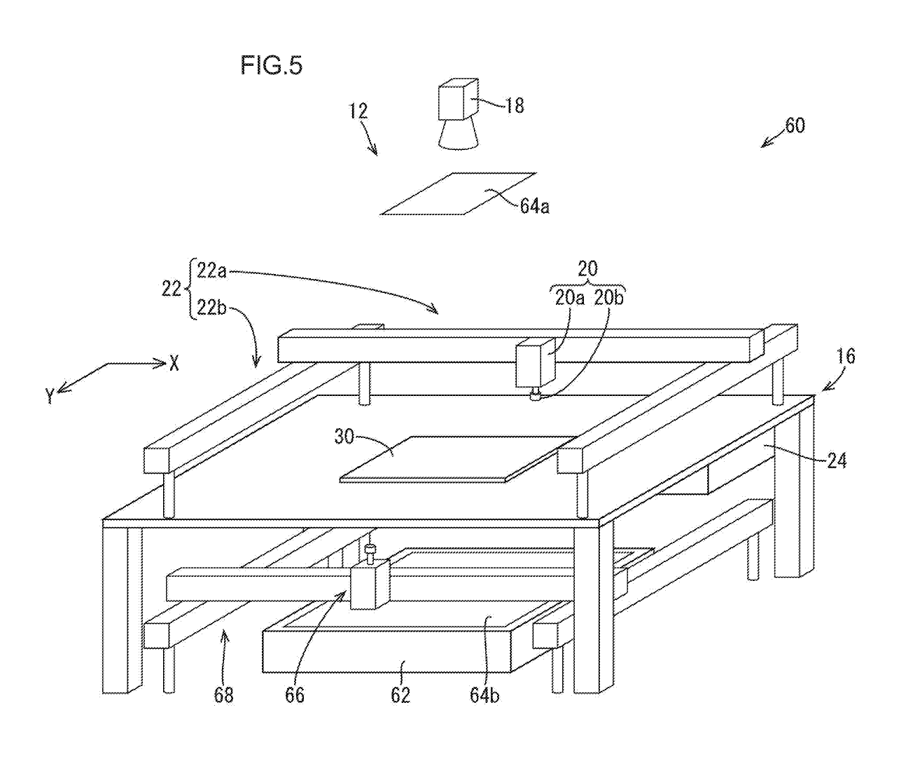

An inspection system 60 for inspecting the liquid crystal panel shown in FIG. 5 is for inspecting the liquid crystal panel 30 to which the polarizers 32a and 32b and the backlight 34 are not attached yet. The inspection system 60 includes an illuminator 62 and a pair of temporary polarizers 64a and 64b. One 64a of the pair of temporary polarizers 64a and 64b is disposed between the camera 18 and the mounting table 16, and the other one 64b of the temporary polarizers 64a, 64b and the illuminator 62 are disposed under the mounting table 16. The mounting table 16 has an opening having an area slightly larger than the active area and smaller than the outline of the liquid crystal panel 30 to supply light from the illuminator 62 to the active area of the liquid crystal panel 30. Under the mounting table 16, a cleaner 66 and a cleaner shifter 68 that are similar in configuration to the above-described cleaner 20 and the cleaner shifter 22 are disposed. In other words, both of the upper surface and the lower surface of the liquid crystal panel 30 placed on the mounting table 16 are cleaned by the cleaners.

The inspection system 60 executes the same inspecting method as executed by the above inspection system 10 except that, in the cleaning process, both the upper surface side and lower surface side of a spot where a lighting defect is detected are cleaned.

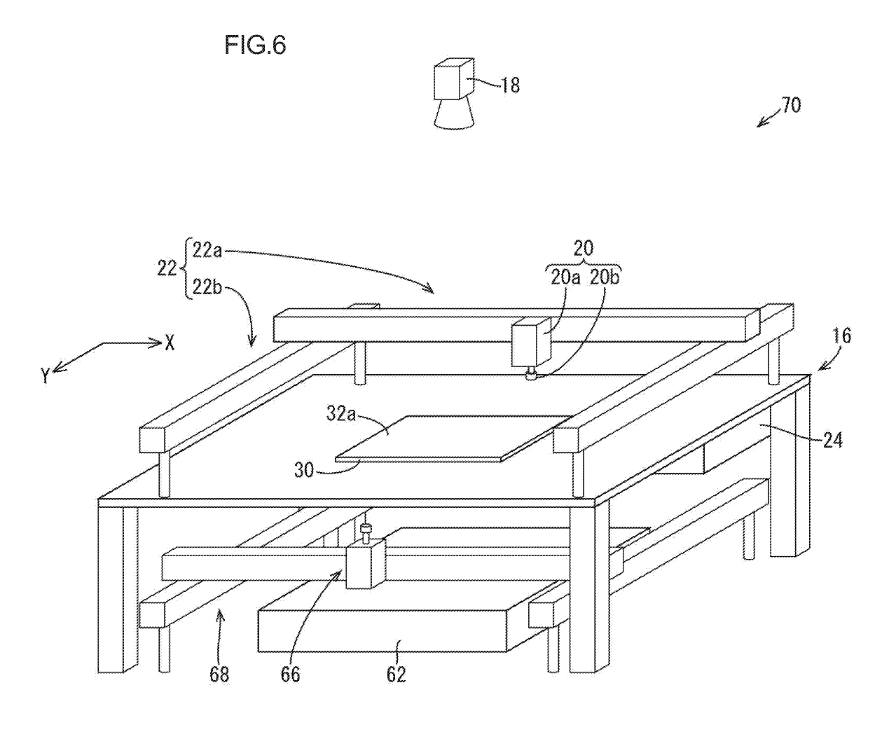

An inspection system 70 for inspecting a liquid crystal panel 30 shown in FIG. 6 is for inspecting the liquid crystal panel 30 to which the pair of polarizers 32a and 32b are attached. The inspection system 70 is thus provided by removing the pair of temporary polarizers 64a and 64b from the inspection system 60 shown in FIG. 5.

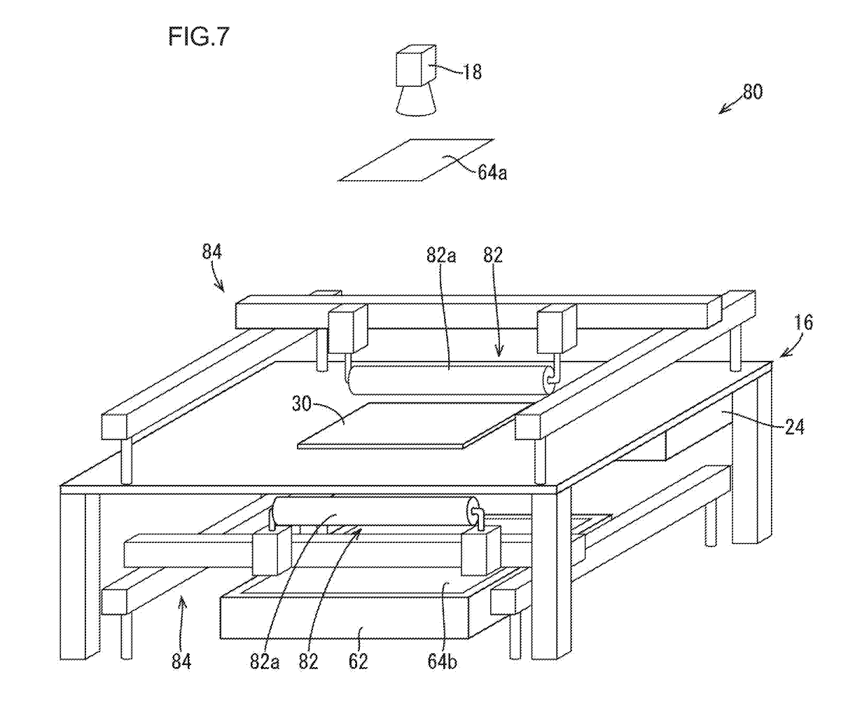

An inspection system 80 for inspecting a liquid crystal panel shown in FIG. 7 is almost the same in configuration as the inspection system 60 shown in FIG. 5 but has a cleaner different from that of the inspection system 60. A cleaner 82 included in the inspection system 80 shown in FIG. 7 has a roller 82a serving as a main unit. This roller 82a is supported rotatably along an axis extending in the X direction and is allowed to move up and down. The roller 82a has a length larger than the width of the liquid crystal panel 30. A cleaner shifter 84 shifts the cleaner 82 in the Y direction. Specifically, shifting the cleaner 82 in the Y direction by the cleaner shifter 84 causes the roller 82a to roll on the liquid crystal panel 30 to clean it up. The cleaner is not limited to stick-shaped or roller-shaped one described herein. Various types of cleaners, such as those configured to blast foreign matter away or eliminate foreign matter with ultrasonic wave or plasma, may be adopted as cleaners that can remove foreign matter and wipe dirt away.

### Second Embodiment

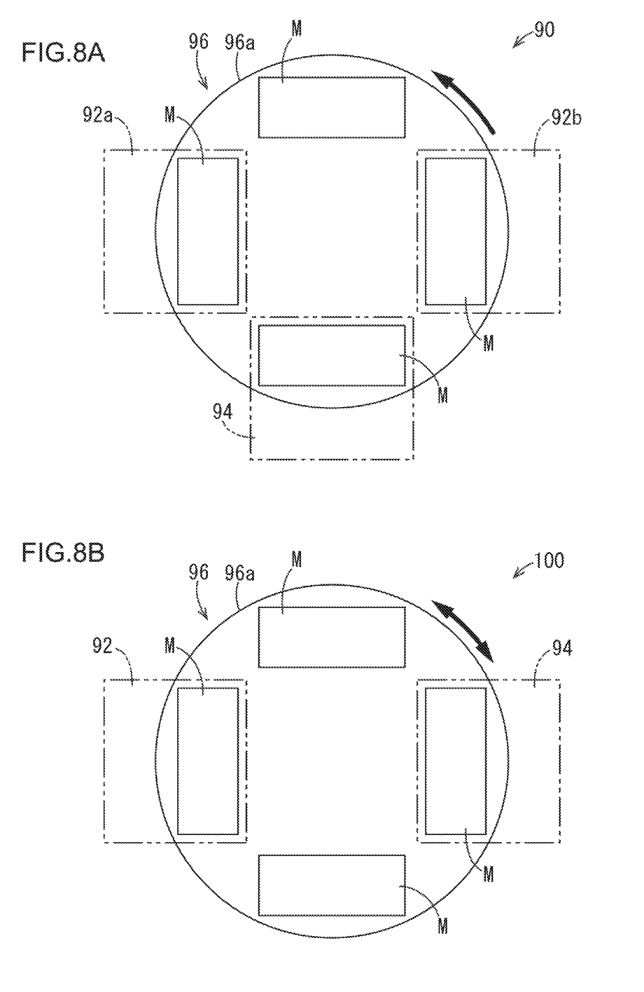

An inspection system 90 for inspecting a liquid crystal panel according to a second embodiment is shown in FIG. 8A. The inspection system 10 according to the first embodiment includes the inspection apparatus having the cleaning function. The inspection system 90 according to the second embodiment includes two inspection apparatuses, i.e., a first inspection apparatus 92a and a second inspection apparatus 92b, and a cleaner 94. The inspection system 90 further includes a rotary base 96 that moves an object to be inspected (liquid crystal module M in FIG. 8A) between the two inspection apparatuses 92a and 92b and the cleaner 94.

The rotary base 96 includes a disc-shaped table 96a serving as a placing unit. Liquid crystal modules M (four modules M in FIG. 8A) can be placed at equal angle intervals on the table 96a, which can be turned along a horizontal plane. The two inspection apparatuses 92a and 92b and the cleaner 94 are arranged such that the first inspection apparatus 92a, the cleaner 94, and the second inspection apparatus 92b are placed in this order circumferentially to encircle the table 96a. Specifically, the table 96a is turned by respective angle intervals at which the liquid crystal modules M are placed. This causes one liquid crystal module M to be positioned in a working position of each of the first inspection apparatus 92a, the cleaner 94, and the second inspection apparatus 92b, in this order. According to the inspection system 90, the first inspection apparatus 92a executes the lighting defect detecting process, the cleaner 94 executes the cleaning process, and the second inspection apparatus 92b executes the flaw detecting process. In other words, the inspection system 90 can simultaneously execute the lighting defect detecting process, the cleaning process, and the flaw detecting process respectively on three liquid crystal modules M. According to the inspection system 90, at a location lying between the inspection apparatus 92a and the inspection apparatus 92b and opposite to the cleaner 94, a liquid crystal module M to be inspected is carried, and a liquid crystal module M having been inspected is carried out.

As described above, the inspection system 90 for inspecting a liquid crystal panel according to the second embodiment is configured to simultaneously execute the lighting defect detecting process, the cleaning process, and the defect detecting process, and therefore can conduct an efficient inspection of the liquid crystal panel 30.

A single inspection apparatus may be adopted. An inspection system 100 for inspecting a liquid crystal panel shown in FIG. 8B includes one inspection apparatus 92. The inspection system 100 causes the one inspection apparatus 92 to execute either the lighting defect detecting process or the defect detecting process, and is therefore configured to simultaneously execute either the lighting defect detecting process or the defect detecting process and the cleaning process. The inspection systems 90 and 100 shown in FIGS. 8A and 8B are each configured such that the rotary base 96 carrying an object to be inspected turns to transfer the object. It is, however, also possible to provide an inspection system in which the inspection apparatus and the cleaner are placed adjacent to each other and an object to be inspected is transferred linearly by a conveyor or the like.

1. A system of inspecting a display panel, the system conducting an inspection of a display panel included in a display device in a process of producing the display device, the system comprising:
an inspection apparatus configured to obtain an image of the display panel relating a lighting condition thereof and process the image and determine whether the display panel has a lighting defect; and
a cleaner configured to clean a surface of the display panel, wherein
if determining that the display panel has a lighting defect, the inspection apparatus is configured to obtain lighting defect information relating the lighting defect, store the lighting defect information, and make the cleaner to clean at least a portion of the display panel having the lighting defect,
the inspection apparatus is configured to determine presence or absence of the lighting defect again at least on the portion of the display panel having the lighting defect after the cleaning,
(i) the inspection apparatus determines that the display panel has no defect if detecting no lighting defect after the cleaning or if determining that pre-cleaning lighting defect information and post-cleaning lighting defect information does not match, and
(ii) the inspection apparatus determines that the display panel has a defect if determining that the pre-cleaning lighting defect information and the post-cleaning lighting defect information match.

2. The system of inspecting a display panel according to claim 1, wherein
the cleaner is configured to clean a part of the display panel, and
if the inspection apparatus detects a lighting defect on the display panel, the cleaner cleans only the portion of the display panel where the lighting defect is detected.

3. The system of inspecting a display panel according to claim 1, wherein the inspection apparatus determines presence or absence of the lighting defect again for only the portion of the display panel where the lighting defect is detected before the cleaning.

4. The system of inspecting a display panel according to claim 1, wherein
if the inspection apparatus detects a lighting defect on the display panel, the cleaner cleans a whole of the display panel, and
the inspection apparatus determines presence or absence of the lighting defect again for the whole of the display panel.

5. The system of inspecting a display panel according to claim 1, further comprising a rotary base including a placing unit on which at least one object to be inspected is placed, the rotary base being configured to turn the placing unit along a horizontal plane to transfer at least the one object between the inspection apparatus and the cleaner.

6. A method of inspecting a display panel of a display device in a process of producing the display device, the method comprising:
a lighting defect detecting process of obtaining an image of the display panel relating a lighting condition thereof and processing the image and determining presence or absence of the lighting defect, and obtaining lighting defect information relating the lighting defect;
a cleaning process of cleaning at least a portion of the display panel having the lighting defect according to determination that the display panel has a lighting defect; and
a defect detecting process of determining presence or absence of the lighting defect again at least on the portion of the display panel having the lighting defect, and
(i) determining that the display panel has no defect if detecting no lighting defect after the cleaning or if determining that pre-cleaning lighting defect information and post-cleaning lighting defect information does not match, and
(ii) determining that the display panel has a defect if determining that the pre-cleaning lighting defect information and the post-cleaning lighting defect information match.
